(19) United States
(12) Patent Application Publication
(10) Pub. No.: US 2007/0083841 A1
(43) Pub. Date: Apr. 12, 2007

(54) Assessing bypass capacitor locations in printed circuit board design

(76) Inventor: John E. Lantz, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/244,610

(22) Filed: Oct. 6, 2005

(51) Int. Cl. G06F 17/50

(52) U.S. Cl. 716/15

(57) ABSTRACT

Systems and methods for assessing bypass capacitor locations in printed circuit board design which are utilized as return current paths are disclosed. In one embodiment a method of assessing bypass capacitor locations in printed circuit board design comprises selecting a first via on a layer of a printed circuit board; selecting a first capacitor for use as a return current path in association with the selected first via; determining a frequency capability supported by the combination of the first via and the first capacitor; and recording the frequency capability in a suitable memory location.

### BACKGROUND

The described subject matter relates to printed circuit board design, and more particularly to assessing bypass capacitor locations in multi-layer printed circuit board design.

Printed circuit boards (PCBs) commonly are designed using advanced computer aided design (CAD) systems, which permit an engineer or designer to design the layout of a PCB in a virtual form before a physical PCB is constructed. Such CAD systems commonly comprise specialized design software that executes on general purpose computing equipment. The design of the virtual PCB and its various components may be stored in a computer-readable medium in one or more data files.

PCBs may include multiple layers, or planes, of circuitry, typically separated by a dielectric. A single net may traverse multiple layers of the PCB. Vias may be used to connect traces from one signal layer of the board to another signal layer, and bypass capacitors may be used to provide a return current path. Technical problems facing designers of multi-layer PCBs include assessing bypass capacitor locations available for use to as, a return current path.

### SUMMARY

In one embodiment, a method of assessing bypass capacitor locations in printed circuit board design comprises selecting a first via on a layer of a printed circuit board; selecting a first capacitor for use as a return current path in association with the selected first via; determining a frequency capability supported by the combination of the first via and the first capacitor; and recording the frequency capability in a suitable memory location.

### BRIEF DESCRIPTION OF THE DRAWINGS

FIG. 1 is a schematic illustration of a computing environment in which one embodiment of a system for assessing bypass capacitor locations in multi-layer printed circuit board design may be implemented.

FIG. 2 is a schematic illustration of a portion of one embodiment of a data file representing a design of a printed circuit board.

FIG. 3 is a flowchart illustrating operations in one embodiment of a method for locating bypass capacitors in printed circuit board design.

FIG. 4 is a schematic illustration one embodiment of a data file for locating bypass capacitors in printed circuit board design.

FIG. 5 is a schematic illustration of one embodiment of a computer system.

### DETAILED DESCRIPTION

Described herein are exemplary system and methods for assessing bypass capacitor locations in printed circuit board design. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

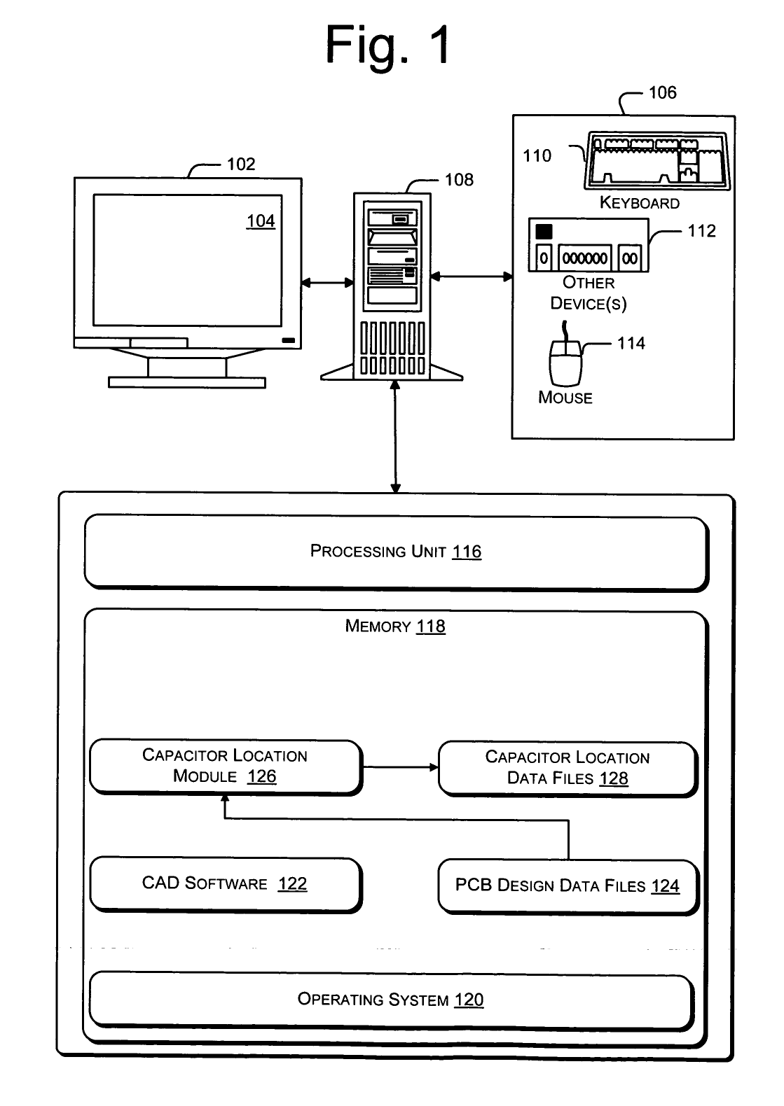

FIG. 1 is a schematic illustration of a computing system 100 in which one embodiment of a system for locating bypass capacitors in multi-layer printed circuit board design may be implemented. This computer system 100 includes a display 102 having a screen 104, one or more user-input devices 106, and a computer 108. The user-input devices 106 can include any device allowing a computer to receive a developer's input, such as a keyboard 110, other device(s) 112, and a mouse 114. The other device(s) 112 can include a touch screen, a voice-activated input device, a track ball, and any other device that allows the system 100 to receive input from a developer and/or a user. The computer 108 includes a processing unit 116 and random access memory and/or read-only memory 118.

Memory 118 includes an operating system 120 for managing operations of computer 108. In an exemplary embodiment one or more application modules 126 executable on the processing unit 116 reside in memory 118. Memory 118 further includes a computer aided design (CAD) software module 122 that may be used to design printed circuit boards. Exemplary CAD software modules 122 include: Allegro PCB Editor design platform available from Cadence Design Systems of San Jose, Calif., USA,.

CAD software module 122 interacts with one or more PCB design data files 124 in memory 118. The PCB design data file(s) 124 include information describing design aspects of one or more printed circuit boards.

Memory 118 further includes a capacitor location module 126 that receives inputs from one or more PCB design files 124 and generates as an output capacitor location data files 128. In one embodiment the capacitor location module 126 and the capacitor location data files 128 are implemented as separate software modules that interact with CAD software 122 and PCB design data files 124. Operation of the system 100 is explained in greater detail below.

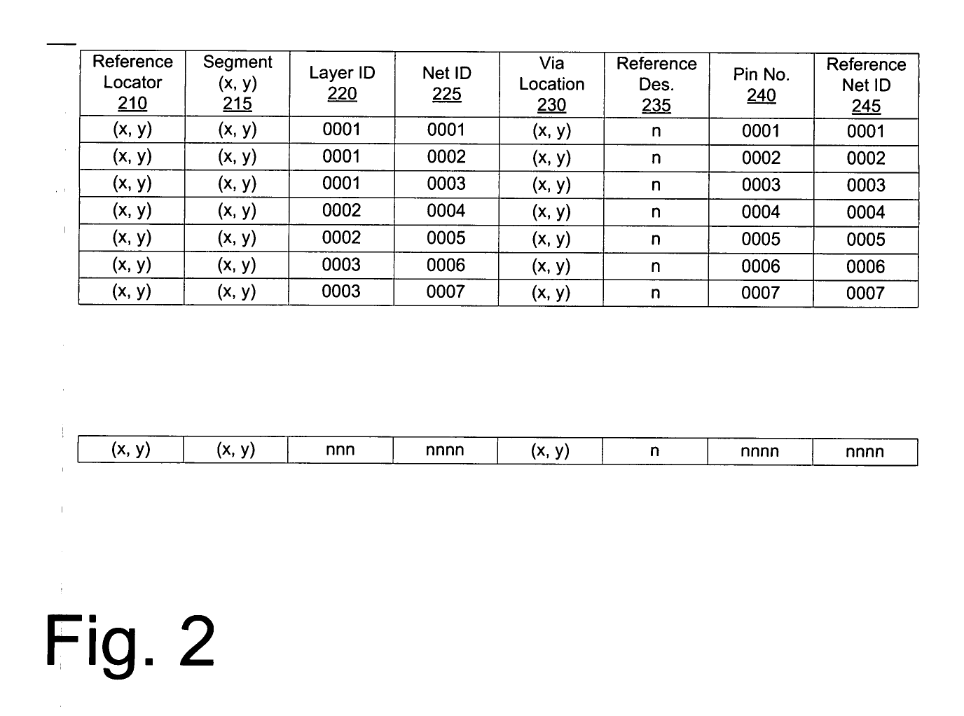

FIG. 2 is a schematic illustration of a portion of one embodiment of a data file representing a design of a printed circuit board. In practice the data depicted in FIG. 2 may be contained in multiple data files or tables. The data is represented in a single table in FIG. 2 for ease of reference. Referring to FIG. 2, a PCB design data file may be stored in a suitable storage medium in the form of a series of tables such as, e.g., a relational database.

In the embodiment depicted in FIG. 2, the following information is derived from data in a CAD file: a Reference Designator (210) identifying a particular component, the (x, y) coordinates of a component, a Segment identifier (215) that identifies the (x, y) coordinates of a trace segment, a layer ID 220 that identifies the layer of the trace segment, a Net ID 225 that identifies the net for the trace segment, a via location 230 that identifies the (x, y) coordinates of a given via, a reference designator 235 that identifies a particular component, a pin no. 240 that identifies a pin for a component, and reference net ID 245 that identifies the net name for the pin for the component.

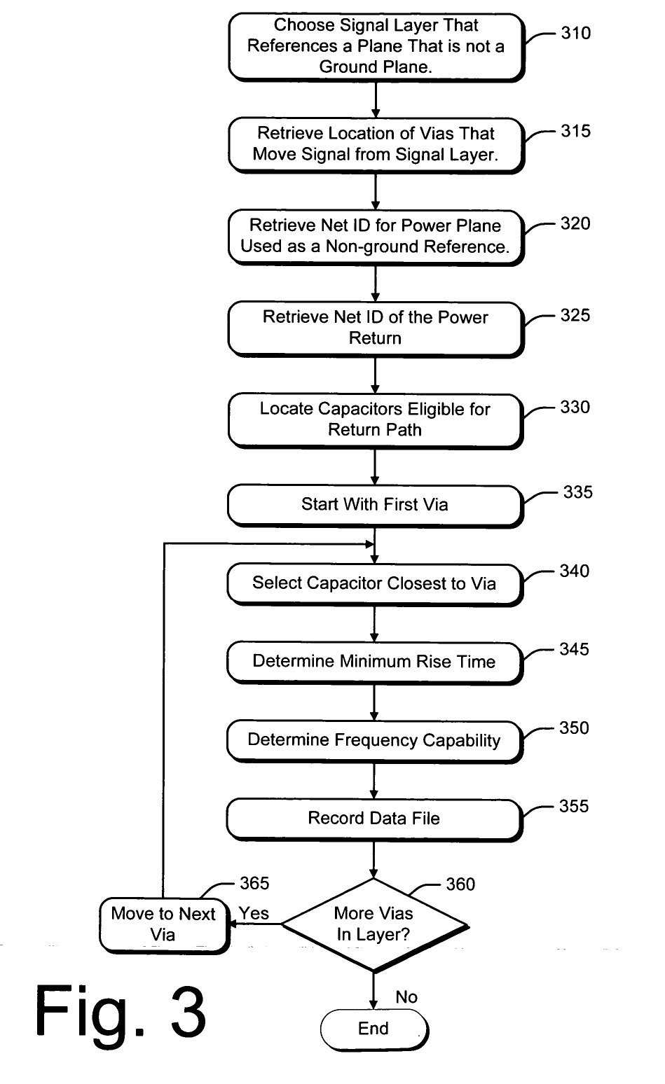

Referring to FIG. 3, at operation 310, the method begins by choosing a signal layer that references a plane that is not a ground plane. For example, the signal layer may reference a plane that is not ground. At operation 315 the location of vias that move the signal from the chosen signal layer are retrieved. For example, referring to FIG. 2, the data table 200 may be searched for vias used to move traces from the chosen signal layer, and the (x, y) coordinates of chosen vias may be retrieved from the table.

At operation 320 the net ID associated with the power plane being used a non-ground reference is retrieved. For example, referring to FIG. 2, the net ID associated with the power plane that is a non-ground plane referenced by the chosen signal layer may be retrieved from the table. At operation 325 the net ID of the power return layer is retrieved, e.g., from the table in FIG. 2.

At operation 330 capacitors eligible for the return path are located. For example, referring to FIG. 2, the table may be searched for capacitors that provide a connection between the chosen non-ground reference layer and

Operations 335-365 define a loop in which the minimum rise time and the frequency capability of each capacitor identified in operation 330 is determined and recorded in a suitable data record. The loop begins by selecting a first via (operation 335) from the group of vias located in operation 315, and selecting the capacitor from the group of capacitors located in operation 330 that is closest to the selected via. In one embodiment the term “closest” refers to the manhattan distance of the electrical path between the selected via and the selected capacitor.

At operation 345 the minimum rise time of a circuit that incorporates the path between the selected via and the selected capacitor is determined. In one embodiment, the rise time is determined using a minimum edge rated determined by the formula: RT =D*10*Tₚ. In this formula RT is the minimum rise time that can be supported by the combination of the capacitor and the via, D is the distance between the signal via (or pin) to the capacitor (or pin), and Tp is the propagation delay. The particular units of measure are not critical. In one embodiment, nanoseconds may be used as a time measurement and inches may be used as a distance measurement. In alternate embodiments metric system measurements may be used.

At operation 350 the frequency supported by the return current path is determined. In one embodiment, the supported frequency may be determined using the formula F =0.35/RT, where RT is the minimum rise time determined in operation 345.

At operation 355 information the minimum rise time determined in operation 345 and the frequency capability determined in operation 350 are recorded in a suitable data file. If, at operation 350, there are more vias in the layer, then control passes to operation 365 and the next via is processed. Operations 340-360 are repeated until all eligible vias on the layer have been processed, at which point the routine ends.

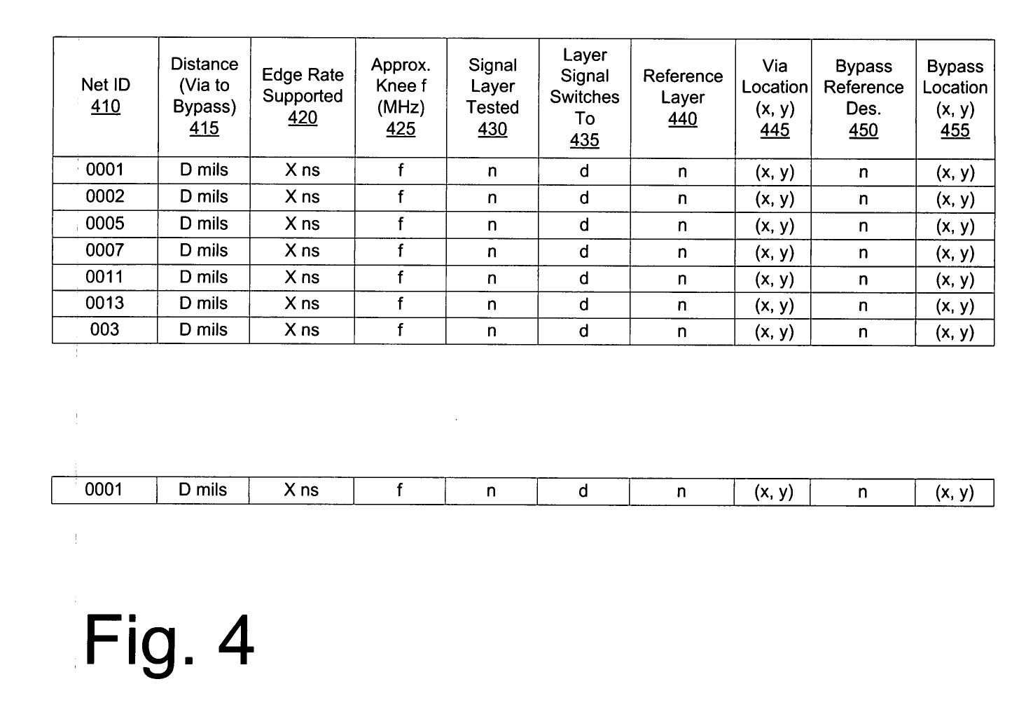

In one embodiment, information compiled in the operations depicted in FIG. 3 may be stored in a data table such as, for example, a relational database. FIG. 4 is a schematic illustration one embodiment of a data table 400 for locating bypass capacitors in printed circuit board design. Referring to FIG. 4, the table includes a series of columns storing entities that represent: a Net ID 410 that identifies a net for a given via; a indicator 415 of the distance from the via to the bypass; an indicator 420 of the edge rate supported by the distance identified in column 415; an indicator 425 of the approximate knee frequency that could be supported by the distance of the capacitor to the signal via; an indicator 430 of the signal layer that references a layer other than ground; an indicator 435 of the layer that the via connects the segment to when leaving the non-ground reference to a ground reference; an indicator 440 of the reference layer that Is not the ground reference layer; an indicator 445 of the (x, y) location of the via; an indicator 450 that identifies the bypass capacitor used as the return current path; and an indicator 455 of the (x, y) location of the bypass capacitor.

The data file 400 may be stored in a suitable memory location such as, e.g., a volatile or non-volatile memory module. The data file 400 may be used in a design process, e.g., by CAD software 122, in selecting suitable capacitors for use as a return current path for signals traversing cross-sectional layers of a PCB. In one embodiment, (or a designer) may use the information to ensure that the capacitor locations for return current paths will support the edge rate specifications for a circuit.

Select embodiments discussed herein may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

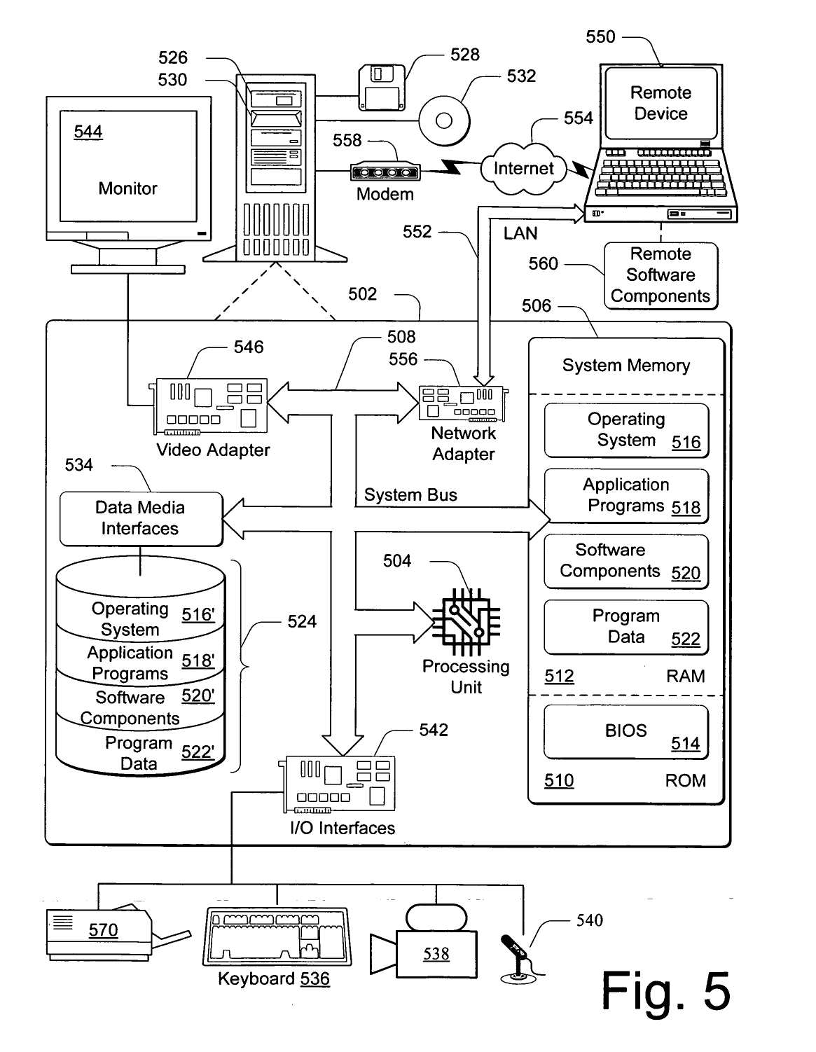

The various components and functionality described herein are implemented with a number of individual computers. FIG. 5 shows components of typical example of such a computer, referred by to reference numeral 500. The components shown in FIG. 5 are only examples, and are not intended to suggest any limitation as to the scope of the functionality of the invention; the invention is not necessarily dependent on the features shown in FIG. 5

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions, programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 5, the components of computer 500 may include, but are not limited to, a processing unit 504, a system memory 506, and a system bus 508 that couples various system components including the system memory 506 to the processing unit 504. The system bus 508 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 500 typically includes a variety of computer-readable media. Computer-readable media can be any available media that can be accessed by computer 500 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network, fiber optic networks, or direct-wired connection and wireless media such as acoustic, RF, infrared and other wireless media. Combinations of any of the above should also be included within the scope of computer readable media.

The system memory 506 includes computer storage media in the form of volatile and/or nonvolatile memory such as read only memory (ROM) 510 and random access memory (RAM) 512. A basic input/output system 514 (BIOS), containing the basic routines that help to transfer information between elements within computer 500, such as during start-up, is typically stored in ROM 510. RAM 512 typically contains data and/or program modules that are immediately accessible to and/or presently being operated on by processing unit 504. By way of example, and not limitation, FIG. 5 illustrates operating system 516, application programs 518, other software components 520, and program data 522.

The computer 500 may also include other removable/non-removable volatile/nonvolatile computer storage media. By way of example only, the computer system of FIG. 5 may include a hard disk drive 524 that reads from or writes to non-removable, nonvolatile magnetic media, a magnetic disk drive 526 that reads from or writes to a removable, nonvolatile magnetic disk 528, and an optical disk drive 530 that reads from or writes to a removable, nonvolatile optical disk 532 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 524 is typically connected to the system bus 508 through a non-removable memory interface such as data media interface 534, and magnetic disk drive 526 and optical disk drive 530 are typically connected to the system bus 408 by a removable memory interface.

The drives and their associated computer storage media discussed above and illustrated in FIG. 5 provide storage of computer-readable instructions, data structures, program modules, and other data for computer 500. In FIG. 5, for example, hard disk drive 524 is illustrated as storing operating system 516′, application programs 518′, software components 520′, and program data 522′. Note that these components can either be the same as or different from operating system 516, application programs 518, software components 520, and program data 522. Operating system 516, application programs 518, other program modules 520, and program data 522 are given different numbers here to illustrate that, at a minimum, they are different copies. A user may enter commands and information into the computer 500 through input devices such as a keyboard 536 and pointing device 538, commonly referred to as a mouse, trackball, or touch pad. Other input devices (not shown) may include a microphone 540, joystick, game pad, satellite dish, scanner, or the like. These and other input devices are often connected to the processing unit 504 through an input/output (I/O) interface 542 that is coupled to the system bus, but may be connected by other interface and bus structures, such as a parallel port, game port, or a universal serial bus (USB). A monitor 544 or other type of display device is also connected to the system bus 506 via an interface, such as a video adapter 546. In addition to the monitor 544, computers may also include other peripheral output devices (e.g., speakers) and one or more printers 570, which may be connected through the I/O interface 542.

The computer may operate in a networked environment using logical connections to one or more remote computers, such as a remote computing device 550. The remote computing device 550 may be a personal computer, a server, a router, a network PC, a peer device or other common network node, and typically includes many or all of the elements described above relative to computer 500. The logical connections depicted in FIG. 5 include a local area network (LAN) 552 and a wide area network (WAN) 554. Although the WAN 554 shown in FIG. 5 is the Internet, the WAN 554 may also include other networks. Such networking environments are commonplace in offices, enterprise-wide computer networks, intranets, and the like.

When used in a LAN networking environment, the computer 500 is connected to the LAN 552 through a network interface or adapter 556. When used in a WAN networking environment, the computer 500 typically includes a modem 558 or other means for establishing communications over the Internet 554. The modem 558, which may be internal or external, may be connected to the system bus 506 via the I/O interface 542, or other appropriate mechanism. In a networked environment, program modules depicted relative to the computer 500, or portions thereof, may be stored in the remote computing device 550. By way of example, and not limitation, FIG. 5 illustrates remote application programs 560 as residing on remote computing device 550. It will be appreciated that the network connections shown are exemplary and other means of establishing a communications link between the computers may be used.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method of assessing bypass capacitor locations in printed circuit board design, comprising:
selecting a first via on a layer of a printed circuit board;
selecting a first capacitor for use as a return current path in association with the selected first via;
determining a frequency capability supported by the combination of the first via and the first capacitor; and
recording the frequency capability in a suitable memory location.

2. The method of claim 1, further comprising:
selecting a second capacitor for use as a return current path;
determining a frequency capability supported by the combination of the first via and the second capacitor; and
recording the frequency capability in a suitable memory location.

3. The method of claim 1, further comprising:
selecting a second via on a layer of a printed circuit board;
selecting a first capacitor for use as a return current path in association with the selected second via;
determining a frequency capability supported by the combination of the second via and the first capacitor; and
recording the frequency capability in a suitable memory location.

4. The method of claim 1, wherein determining a frequency capability supported by the combination of the first via and the first capacitor comprises:
determining a minimum rise time supported by the combination of the first via and the first capacitor; and
using the minimum rise time to determine a frequency capability.

5. The method of claim 4, wherein determining a minimum rise time supported by the combination of the first via and the first capacitor comprises calculating the minimum rise time from a distance between the first via and the first capacitor and a propagation delay between the first via and the first capacitor.

6. A computer program product comprising logic instructions stored on a computer-readable medium which, when executed by a processor, configure the processor to:
select a first via on a layer of a printed circuit board;
select a first capacitor for use as a return current path in association with the selected first via;
determine a frequency capability supported by the combination of the first via and the first capacitor; and
record the frequency capability in a suitable memory location.

7. The computer program product of claim 6, further comprising logic instructions stored on a computer-readable medium which, when executed by a processor, configure the processor to:
select a second capacitor for use as a return current path;
determine a frequency capability supported by the combination of the first via and the second capacitor; and
record the frequency capability in a suitable memory location.

8. The computer program product of claim 6, further comprising logic instructions stored on a computer-readable medium which, when executed by a processor, configure the processor to:
select a second via on a layer of a printed circuit board;
select a first capacitor for use as a return current path in association with the selected second via;
determine a frequency capability supported by the combination of the second via and the first capacitor; and
record the frequency capability in a suitable memory location.

9. The computer program product of claim 6, further comprising logic instructions stored on a computer-readable medium which, when executed by a processor, configure the processor to:
determine a minimum rise time supported by the combination of the first via and the first capacitor; and
use the minimum rise time to determine a frequency capability.

10. The computer program product of claim 9, further comprising logic instructions stored on a computer-readable medium which, when executed by a processor, configure the processor to calculate the minimum rise time from a distance between the first via and the first capacitor and a propagation delay between the first via and the first capacitor.

11. A system, comprising:
a processor;
a memory module connected to the processor and comprising logic instructions which, when executed by the processor, configure the processor to:
select a first via on a layer of a printed circuit board;
select a first capacitor for use as a return current path in association with the selected first via;
determine a frequency capability supported by the combination of the first via and the first capacitor; and
record the frequency capability in a suitable memory location.

12. The system of claim 11, further comprising logic instructions stored in the memory module which, when executed by a processor, configure the processor to:
select a second capacitor for use as a return current path;
determine a frequency capability supported by the combination of the first via and the second capacitor; and
record the frequency capability in a suitable memory location.

13. The system of claim 11, further comprising logic instructions stored in the memory module which, when executed by a processor, configure the processor to:
select a second via on a layer of a printed circuit board;
select a first capacitor for use as a return current path in association with the selected second via;
determine a frequency capability supported by the combination of the second via and the first capacitor; and
record the frequency capability in a suitable memory location.

14. The system of claim 11, further comprising logic instructions stored in the memory module which, when executed by a processor, configure the processor to:
determine a minimum rise time supported by the combination of the first via and the first capacitor; and
use the minimum rise time to determine a frequency capability.

15. The system of claim 14, further comprising logic instructions stored in the memory module which, when executed by a processor, configure the processor to calculate the minimum rise time from a distance between the first via and the first capacitor and a propagation delay between the first via and the first capacitor.

16. A system, comprising:
means for generating a first data file representing a design for a printed circuit board;
means for associating vias with a candidate return path capacitor; and
means for determining a frequency characteristic of a circuit comprising a via in combination with a candidate return path capacitor.

17. The system of claim 16, wherein the means for generating a first data file representing a design for a printed circuit board comprises a CAD software module executing on a suitable processor.

18. The system of claim 16, further comprising means for determining a rise time characteristic of a circuit comprising a via in combination with a candidate return path capacitor.

19. The system of claim 18, further comprising means for storing the rise time characteristic and the frequency characteristic in a suitable memory location.

20. The system of claim 19, further comprising means for using the rise time characteristic and the frequency characteristic in designing a printed circuit board.
